(19) United States
(12) Patent Application Publication
(10) Pub. No.: US 2005/0131748 A1
(43) Pub. Date: Jun. 16, 2005

(54) Vacation request processing system incorporating call volume data

(76) Inventor: Jane Smith Parker, Douglasville, GA (US)

Correspondence Address: THOMAS, KAYDEN, HORSTEMEYER & RISLEY, LLP/;BELLSOUTH I.P. CORP, 100 GALLERIA PARKWAY, SUITE 1750, ATLANTA, GA, 30339, US

(21) Appl. No.: 10/735,407

(22) Filed: Dec. 12, 2003

(51) Int. Cl. G06F 17/60

(52) U.S. Cl. 705/8

(57) ABSTRACT

Systems and methods for vacation request processing, which in one embodiment among many, can be broadly summarized by a representative method of processing a vacation request of an employee based on a workload estimate, which includes a work statistic that is used to operate a call center, together with vacation eligibility criteria. Another embodiment can be described as a vacation request processing system that has logic configured to provide a vacation eligibility criteria and a workload estimate, which includes a work statistic that is used to operate a call center, and logic configured to process the vacation request by using the workload estimate and the vacation eligibility criteria.

### TECHNICAL FIELD

The present disclosure is generally related to vacations and, more particularly, is related to vacation request processing.

### BACKGROUND

Various aspects of call center operations are typically directed by an operations group made up of a number of staff personnel who operate a computer system that may be referred to as a workforce management computer system. This computer system is communicatively coupled to a communication switch that provides telecommunication services to one or more call centers. Telephone call statistics related to call center operations are transmitted by the communication switch to the workforce management computer system, where the operations group then performs data gathering, analysis, and prediction with the goal of managing the labor force that operates the call center. In addition to obtaining call statistics from the communication switch, the data gathering aspect also includes obtaining information from the call center, such information including operator attendance data, operator efficiency data, and operator availability data.

Such operator-related information is often provided by call center staff who accept guidance from the operations group to suitably increase or decrease the number of operators at any given instance based on current and predicted call volume. The staffing personnel also carry out attendance tracking and record-keeping related to vacations and other absences of operators of the call center. This data may be recorded on paper in certain cases, and may be recorded on computers in other cases. Typically, the call center staff carry out vacation request processing with a limited amount of information. Such information may pertain to checking vacation eligibility of the particular employee, checking the number of operators absent/available on the day(s) for which the vacation has been requested, and at best an approximate idea of the expected workload on those days. While the expected workload information may be available to the operations group managing the workforce management computer system, this information, even when provided to the call center staff is often used in a best-guess fashion using manual interpolation techniques that often ignore interdependencies in labor force management between multiple call centers. This becomes a significant issue when customer calls have to be re-routed amongst several call centers due to a surge in call volume at any instance.

Additionally, the granting of vacation requests becomes further complicated if two operators request a vacation day off on the same day when the workload permits a day off to only one operator. Under this condition, it would be desirable to have an unbiased set of rules that can be followed to provide a fair and objective decision in granting/denying the vacation request. Unfortunately, present-day call centers do not have such a system in place and consequently, whether intentional or otherwise, a less-than-objective determination may be made by the call center staff.

This type of vacation request processing that uses approximation and guesswork in putting together disparate pieces of information, often in a subjective and non-standardized fashion, leads to various inefficiencies in managing the labor force of one or more call centers. Such inefficiencies contribute to a loss in terms of resources, time, and money.

It is therefore desirable to provide a vacation request processing system that addresses these problems.

### SUMMARY OF THE DISCLOSURE

One embodiment among others, of the present disclosure includes processing a vacation request by using a workload estimate based on call volume statistics together with vacation eligibility criteria incorporating one or more rules.

Other systems, methods, and/or computer program products according to embodiments will be or become apparent to one skilled in the art upon review of the following drawings and detailed description. It is intended that all such additional systems, methods, and/or computer program products be included within this description, and be within the scope of the present disclosure.

### BRIEF DESCRIPTION OF DRAWINGS

Many aspects of the disclosure can be better understood with reference to the following drawings. The components in the drawings are not necessarily to scale, emphasis instead being placed upon clearly illustrating the principles of the present disclosure. Moreover, in drawings, like reference numerals designate corresponding parts throughout the several views.

FIG. 1 is a block diagram of a workforce management system communicatively coupled to a communications switch that provides switching services to one or more workforce centers.

FIG. 2 is a block diagram of a workforce management system comprising a network of computing elements, the management system being communicatively coupled to a communication switch that is a part of the POTS network and/or the Internet.

FIG. 3 is a block diagram illustrating various functional blocks of one embodiment among many, of a computing element of the workforce management system of FIG. 1, where the computing element is configured to process one or more vacation requests.

FIG. 4 is a block diagram illustrating various functional blocks of one embodiment among many, of a communication switch processing unit that is located inside the communications switch of FIG. 1, the communication switch processing unit being communicatively coupled to the workforce management system of FIG. 3.

FIG. 5 is a block diagram illustrating various functional blocks of one embodiment among many, of a computer located in a call center, the computer being configured to be a part of a vacation request processing system incorporated in the workforce management system of FIG. 3.

FIG. 6 is a block diagram illustrating various functional blocks of one embodiment among many, of a vacation request processing system.

### DETAILED DESCRIPTION

While the description below refers to certain exemplary embodiments, it is to be understood that the disclosure is not limited to these particular embodiments. On the contrary, the intent is to cover all alternatives, modifications and equivalents included within the spirit and scope of the disclosure as defined by the appended claims. Also, the terminology used herein is for the purpose of description and not of limitation. One example of such terminology, is with reference to use of the word “vacation.” It will be understood that the term vacation encompasses various types of absences, such as, but not limited to, personal/family vacations, unpaid leave, holidays, medical leave, unpaid hours, and overtime hours.

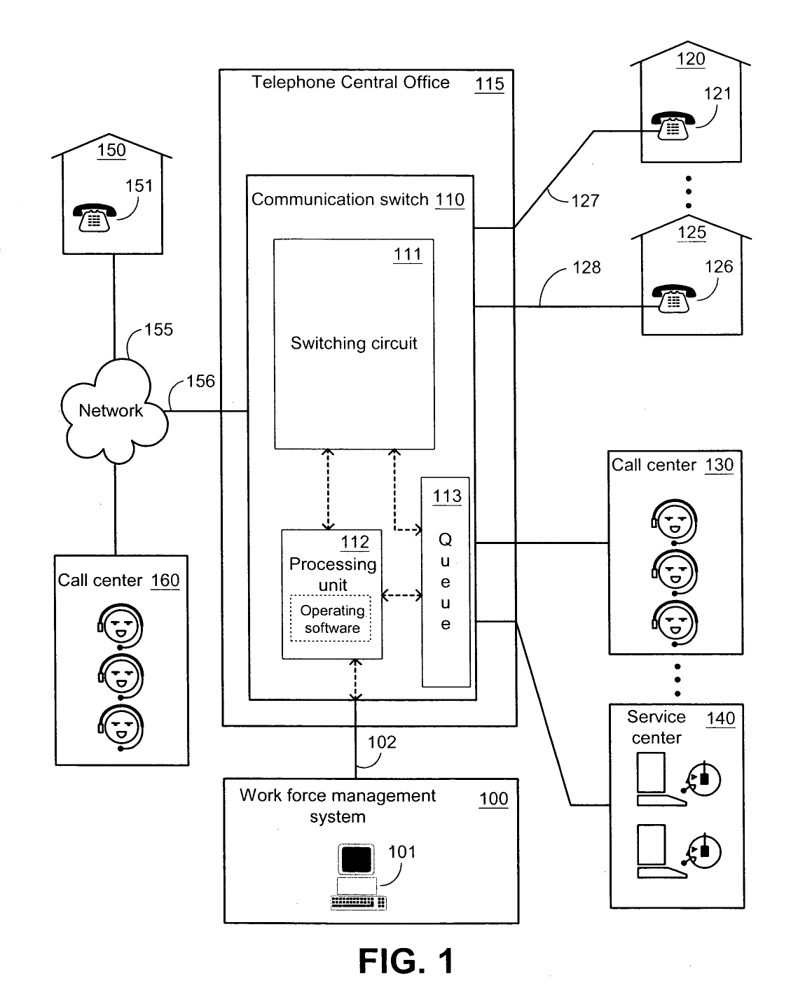

FIG. 1 is a block diagram of a workforce management system 100 communicatively coupled to a communications switch 110, which in this exemplary embodiment, is a plain old telephone service (POTS) switch located in a telephone central office (CO) 115. The POTS switch is connected on its trunk side to network 155, which in this first embodiment, is the public switched telephone network (PSTN). The POTS switch of this embodiment provides telephone service to many customers, such as residential customers located in residences 120 and 125 that are connected to the line side of the POTS switch via links 127 and 128 that constitute the telephone local loop. These residences contain telephones 121 and 126 as shown, but may additionally accommodate communication devices such as PCs used by the residential customers for Internet access.

The POTS switch of this embodiment may be further configured to provide telephone services via the PSTN of this embodiment, to an additional residential customer located in residence 150. The residential customer in residence 150 communicates to a customer in residence 120, by obtaining a connection through the PSTN and through the POTS switch of this embodiment. This type of customer who is located outside an local access transport area (LATA) served by the switch, is classified as a long-distance customer, and is sometimes referred to as an inter-LATA customer.

Communication switch 115 is further configured to provide telecommunication services such as routing telephone calls from telephone customers in residences 120, 125, and 150 to telephone operators located in a call center 130. The telephone operators inside call center 130 provide a number of customer services such as directory assistance and operator-assisted call connections.

In a second exemplary embodiment, communication switch 110 comprises a digital subscriber line access multiplexer (DSLAM) to provide Internet access and various data services to residences 120, 125, and 150, and also to business customers located in businesses (not shown) that are connected to the DSLAM either via the local loop or via network 155. The DSLAM of this second exemplary embodiment is typically configured to route data traffic to a server that is located in an Internet service provider (ISP) location. Routing of data traffic is carried out over network 155 that in this exemplary second embodiment, comprises the Internet.

In a third exemplary embodiment, communication switch 110 comprises a device that is referred to in the industry as a softswitch, or alternatively comprises a device that is referred to in the industry as a gateway. The softswitch/gateway of this third exemplary embodiment switches data packets in providing data services to residences 120, 125, and 150, and also to business customers located in businesses (not shown) that are connected to the device either via the local loop or via network 155. Network 155 will comprise the Internet in this third exemplary embodiment.

The softswitch/gateway of this exemplary embodiment is not necessarily confined to providing data services, but can also be configured to provide voice services over a packet network such as the Internet. One example of such a voice service uses voice-over-Internet protocol (VoIP) to carries voice data as IP packets over the network. With reference to this example, residence 150 or a business (not shown) that is connected to the Internet (network 155) is, in various embodiments, an international customer located in a country outside the country in which the communication switch 110 is located. Similarly, a call center 160 that is shown connected into network 155 is, in various embodiments, a call center located in a foreign country. Call center 160 and other service centers that are connected to network 155 at an international location, are, in various embodiments, used to provide services to customers such as the ones in residences 120, 125, and 150.

Drawing further attention to FIG. 1, service center 140 is connected to communications switch 140 to permit service center operators to provide additional services to residential and/or business customers. Such services include functions that are similar to that provided by the call center operators, but also comprise many other types of services that include voice as well as data operations.

As one example among many, such services include manual e-mail responses that do not require telephone conversations. A second example involves responding to customer queries related to product support. A third example involves handling of a business transaction such as an automated credit card payment. It will be understood that such transactions encompass a wide variety of voice transactions carried out over the PSTN, as well as data transactions carried out over a private and/or a public data network including the PSTN and the Internet. It further includes voice transactions that are carried over data networks, for example, as a Voice-over-IP call.

Work force management system (WFMS) 100 that is shown communicatively coupled to switch 115, includes a workforce computer system 101 that, in various embodiments, comprises one machine or several machines. In various embodiments, these machines are PCs, workstations, or other computing platforms, that are used in an individual configuration, or comprise a network of several units. WFMS 100 is typically located either inside CO 115 or in an outside office. Typically, WFMS 100 is located in an outside office, that is in certain instances, a geographically remote office located in a city other than the city in which the CO 115 is located.

WFMS 100 is configured to manage certain operations of centers such as call center 130 and service center 140. Such operations include call-volume analysis, call-volume prediction, and producing work schedules for the call center operators based on the predicted call-volume. Call-volume analysis is carried out by obtaining from the communication switch 110, call-statistics such as total number of calls routed to one or more centers, and types of such calls routed, and also by obtaining from one or more call centers, call-handling-statistics such as calls answered, calls abandoned, and average wait times. Call-statistics are typically obtained via digital data that is transported on link 102 from switch 110 to WFMS 100. In various embodiments, link 102 uses various types of hardware and software. In one example among many, link 102 is a circuit switched link such as a T1 line carrying TDM data. In a second example, link 102 is a packet switched link carrying data packets using a TCP/IP format.

Once WFMS 100 receives the call-statistics, a call-load history is generated from which future call-loads are predicted. Based on these predictions, the work force in one or more call centers are scheduled in a process that is known in the industry as “tours.” Work scheduling is used to adjust the number of call operators at various instances of time depending upon expected call volume. Furthermore, switching processes in switch 110 that are related to routing of calls to the call centers, as well as providing call-weighting (e.g., by adding wait times) to such calls, can be modified at switch 110 upon request from WFMS 100. Such a request is often carried out via telephone calls between the staff of WFMS 100 and those of CO 110.

WFMS 100 is also configured to handle certain other functions related to call center operators. Some of these functions include payroll, attendance, record keeping, and personnel management tasks such as hiring and firing.

Drawing attention to communication switch 110 of FIG. 1, a few operational blocks that are associated with call center operations are shown inside switch 110. Switching circuit 111 carries out the switching function to switch calls originated by customers such as a residential customer from residence 120. Such a call may relate to directory assistance where the customer is seeking directory information, requiring manual servicing by an operator in call center 130. Switching circuit 111 provides the necessary connections to direct this call, in digital data form, to a queue 113. Queue 113 is typically a first-in-first-out (FIFO) buffer system that regulates the transfer of this call together with any others that may be occurring during this time, to call center 130 or service center 140. The queueing process also typically incorporates a weighting scheme to decide the order in which these calls are placed into, and consequently routed out of, the queue 113. One example among many, of a weighting scheme uses a “wait time” factor that determines how quickly an individual call is processed and transported out of the switch. The call is routed from queue 113 to a call center operator in call center 130 for example. Processing unit 112 is typically, a central processing unit (CPU) comprising hardware and software that is a part of communication switch 110. The software inside processing unit 112 includes operating software that controls switching circuit 111, queue 113 and other circuits inside communication switch 110. Processing unit 112 further includes software for interfacing switch 110 to WFMS 100 via link 102.

It will be understood that similar mechanisms for switching and queuing may be employed to interface switch 110 to call center 160 to provide customer service for customers in residences 120, 125, and 150. It will also be understood that WFMS 100 may be communicatively coupled to communication switch 110 through network 155, thereby allowing WFMS 100 to be remotely located.

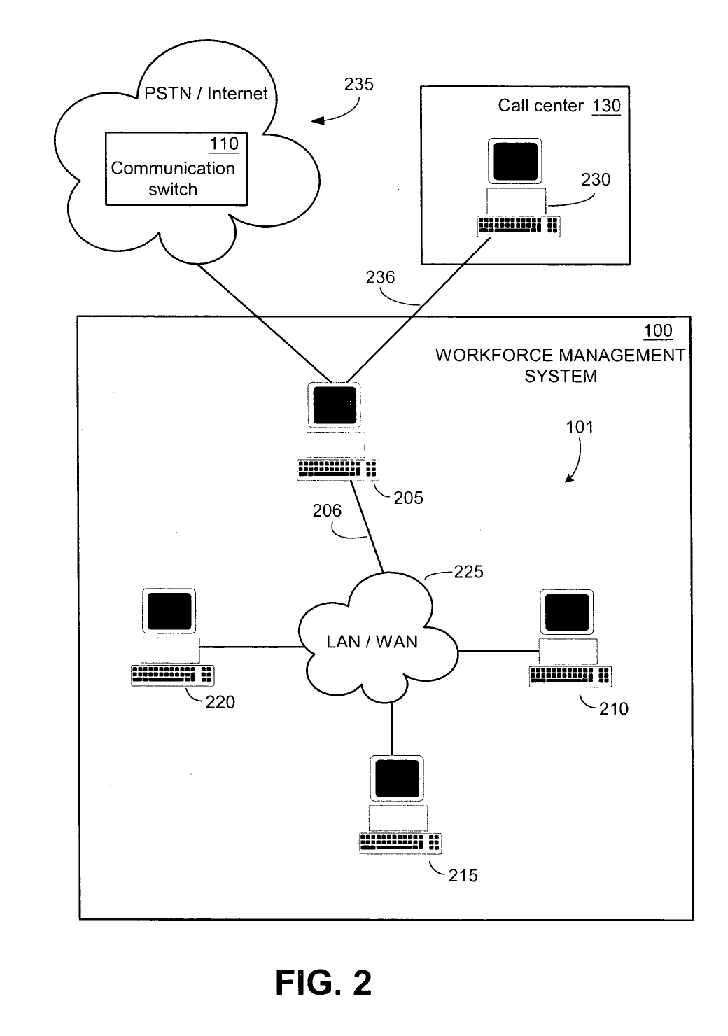

FIG. 2 illustrates one exemplary embodiment among several such embodiments, wherein WFMS 100 comprises workforce computer system 101 configured as a network of computing elements. Computing elements 205, 210, 215, 220, and 230 are five example elements that comprise five PCs, five workstations, five work platforms, and combinations thereof. Element 205 operates in this example as a server/gateway device. While five such elements are shown in FIG. 2 it will be understood that the number of elements in such a network configuration can be any number greater than two. The five elements of FIG. 2 are interconnected to each other by a network 225 that is a local area network (LAN) and/or a wide area network (WAN) comprising a variety of hardware and software elements that incorporate various standards and formats. One example among many, of such a network is an Ethernet LAN transporting data packets using an Ethernet protocol. A second example is a WAN transporting data cells in an ATM format. The five elements shown in this example, can be located inside a single building or may alternatively, be housed in several buildings that include one or more call centers. They can also be interconnected to each other, to other communication devices, and to communication links in several other appropriate configurations.

In a first exemplary configuration, element 205 operates in a client-server configuration where communication switch 110 that is shown as a part of network 235, operates as a server and element 205 operates as its client. In the context of such a configuration, link 102 is a communication link that transports data packets, and network 235 is a packet network such as the Internet.

In a second exemplary configuration, element 205 operates in a master-slave configuration where communication switch 110 that is shown as a part of network 235, operates as a master device and element 205 its slave. In the context of this second exemplary configuration, link 102 is a communication link that transports circuit switched data, and network 235 is a circuit switched network such as the PSTN.

In some embodiments, element 205 is communicatively coupled to one or more computers that are located in one or more call/service centers, either through communication switch 110 or directly through other communication links as indicated by the dashed line of link 236. The all/service centers are located within a local access transport area (LATA) or alternatively located outside a LATA, including international locations.

FIG. 2 shows one example where a computer 230 in call center 130 is coupled to element 205 through link 236. Link 236 operates in a manner similar to that described for link 102 above. Among other data, administrative information, such as employee work statistics, is electronically communicated by the computer 230 in call center 130 to the computing element 205.

Generally, element 205 provides a number of software application modules that is used locally by the computing elements interconnected via network 225, and/or remotely by the computer 230 in call center 130 as well as computers elsewhere that are communicatively coupled to element 205. While it is not necessary that all these software modules be solely resident in computing element 205, it is generally understood that it is configured in this manner in many system applications.

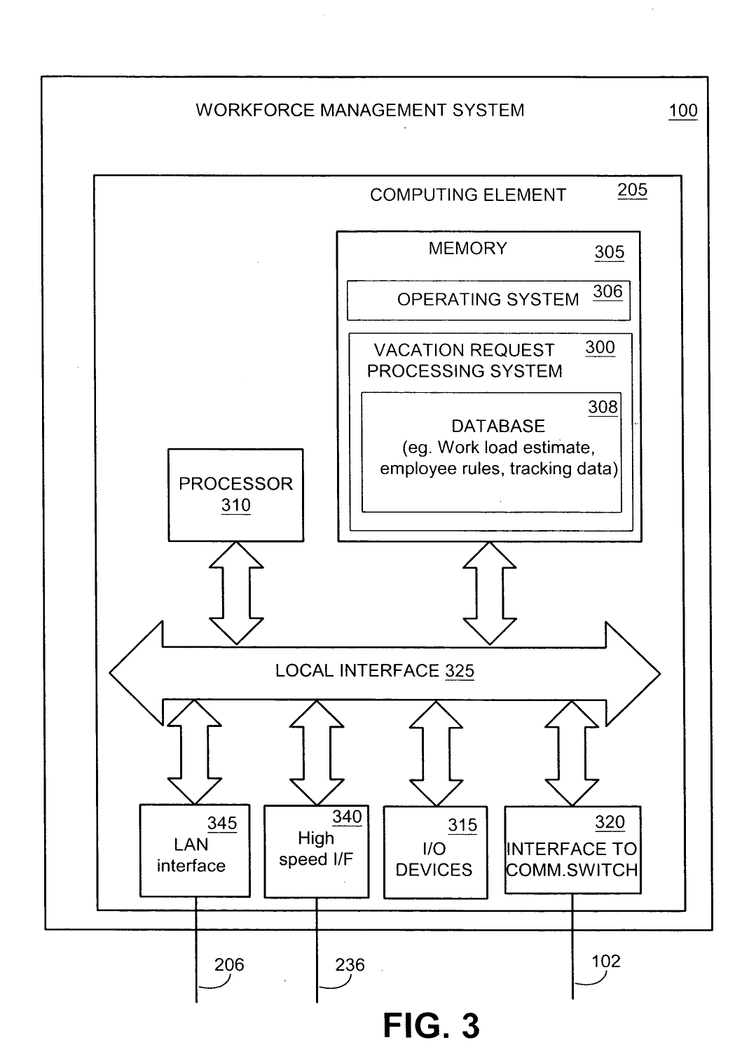

FIG. 3 is a block diagram illustrating various functional blocks incorporated inside element 205 of WFMS 100. Generally, in terms of hardware architecture, as shown in FIG. 3, computing element 205 includes several elements that are communicatively coupled to one another via a local interface 325. Some example elements include a processor 310, memory 305, a communication switch interface 320, a LAN interface 345, a high-speed interface 340, and one or more input/output (I/O) devices 315 (or peripherals).

The local interface 325 can be, for example but not limited to, one or more buses or other wired or wireless connections, as is known in the art. The local interface 325 can have additional elements, which are omitted for simplicity, such as controllers, buffers (caches), drivers, repeaters, and receivers, to enable communications. Further, the local interface can include address, control, and/or data connections to enable appropriate communications among the aforementioned components.

The processor 310 is a hardware device for executing software, particularly that stored in memory 305. The processor 310 can be any custom made or commercially available processor, a central processing unit (CPU), an auxiliary processor among several processors associated with the computing element 205, a semiconductor based microprocessor (in the form of a microchip or chip set), a macroprocessor, or generally any device for executing software instructions.

The memory 305 includes any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 305 can incorporate electronic, magnetic, optical, and/or other types of storage media. Note that the memory 305 can have a distributed architecture, where various components are situated remote from one another, but can be accessed by the processor 310.

The software in memory 305 includes one or more separate programs, each of which comprises an ordered listing of executable instructions for implementing logical functions. In the example of FIG. 3, the software in the memory 305 includes a vacation request processing 300 that is one among several embodiments of the present disclosure, and a suitable operating system (O/S) 306. A nonexhaustive list of examples of suitable commercially available operating systems 306 is as follows: (a) a Windows operating system available from Microsoft Corporation; (b) a Netware operating system available from Novell, Inc.; (c) a Macintosh operating system available from Apple Computer, Inc.; (d) a UNIX operating system, which is available for purchase from many vendors, such as the Hewlett-Packard Company, Sun Microsystems, Inc., and AT&T Corporation; (e) a LINUX operating system, which is freeware that is readily available on the Internet; or (f) an appliance-based operating system, such as that implemented in handheld computers or personal data assistants (PDAs) (e.g., PalmOS available from Palm Computing, Inc., and Windows CE available from Microsoft Corporation). The operating system 306 essentially controls the execution of other computer programs, such as the vacation scheduling system 300, and provides scheduling, input-output control, file and data management, memory management, and communication control and related services.

In some embodiments, the vacation request processing 300 is implemented using logic incorporated in programs such as a source program, executable program (object code), script, or any other entity comprising a set of instructions to be performed. When a source program, then the program needs to be translated via a compiler, assembler, interpreter, or the like, which may or may not be included within the memory 305, so as to operate properly in connection with the O/S 306. Furthermore, the vacation request processing 300 can be written as (a) an object oriented programming language, which has classes of data and methods, or (b) a procedure programming language, which has routines, subroutines, and/or functions, for example but not limited to, C, C++, Pascal, Basic, Fortran, Cobol, Perl, Java, and Ada.

The I/O devices 315 include input devices, for example but not limited to, a keyboard, mouse, scanner, microphone, etc. Furthermore, the I/O devices 315 also include output devices, for example but not limited to, a printer, display, etc. Finally, the I/O devices 315 further include devices that communicate both inputs and outputs, for instance but not limited to, a modulator/demodulator (modem; for accessing another device, system, or network), a radio frequency (RF) or other transceiver, a telephonic interface, a bridge, a router, etc.

Also shown in computing element 205 is a communication interface 320 that provides a digital communication link 102 between computing element 205 and various telecommunication devices such as a computer located in a call center, a computer located at an international location, and a communication switch such as communication switch 110 of FIGS. 1 and 2.

If the computing element 205 is a PC, workstation, or the like, the software in the memory 305 further includes a basic input output system (BIOS) (omitted for simplicity). The BIOS is a set of essential software routines that initialize and test hardware at startup, start the O/S 306, and support the transfer of data among the hardware devices. The BIOS is stored in ROM so that the BIOS can be executed when the computing element 205 is activated.

When the computing element 205 is in operation, the processor 310 is configured to execute software stored within the memory 305, to communicate data to and from the memory 305, and to generally control operations of the computing element 205 pursuant to the software. The vacation request processing 300 and the O/S 306, in whole or in part, but typically the latter, are read by the processor 310, perhaps buffered within the processor 310, and then executed.

When the vacation request processing 300 is implemented in software, as is shown in FIG. 3 hereafter, it should be noted that the vacation request processing 300 can be stored on any computer readable medium for use by or in connection with any computer related system or method. For example, the vacation request processing 300 can be detailed in a computer program or script that runs on a stand-alone server, a network server, or on one or more computers that are part of a network.

In the context of this document, a computer readable medium is an electronic, magnetic, optical, or other physical device or means that can contain or store a computer program for use by or in connection with a computer related system or method. The vacation request processing 300 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the vacation request processing 300 is implemented using hardware logic, the vacation request processing 300 can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc. The hardware can be housed in a stand-alone computer or in one or more computers of a network.

Drawing attention to vacation request processing 300 of FIG. 3, one functional block among many is shown as a database 308. Other functional blocks that operate to implement vacation request processing 300 have not been shown, and will be understood in the context of implementations as described in the following pages. It will also be understood, that while the vacation request processing 300 is illustrated as resident inside computing element 205, some or all of the software/hardware of this system 300 can be resident in other elements. As mentioned earlier, one example of such an implementation involves software located in one or more machines that are communicatively coupled to one another.

Database 308 comprises, in one exemplary embodiment, data that is formatted for processing by a Structured Query Language (SQL) program. In alternative embodiments, other programs such as, but not limited to, Microsoft Excel™, Microsoft Access™, and Oracle, are used. Also, in other embodiments, unformatted data is stored in database 308. In one of several embodiments, database 308 contains data that is relevant to vacation scheduling system 300, for example, but not limited to, employee data related to the various operators employed in one or more call centers. This data may be of an individual nature, and/or of a cumulative nature encompassing a number of operators.

Examples of data stored in database 308, include, but are not limited to, vacation eligibility rules that are based on various factors such as pay-grade and years of service, vacation taken, vacation balance, medical leave rules, medical leave taken, hours that an operator(s) was unavailable to handle calls, training hours, holiday information, compensatory time off, paid/unpaid absences, overtime rules and overtime data.

Database 308 may additionally contain one or more work load estimates that are derived from call-related statistics that have been provided by a communication switch, such as communication switch 110 of FIGS. 1 and 2, via communication switch interface 320. In this context, communication switch interface 320 comprises a digital interface device that performs an electronic handshake with processing unit 112 located inside the communication switch 110, and downloads pertinent data via link 102. Alternatively, other methods are employed to configure database 308. One such method includes a manual entry by an operator through I/O devices 315 that in this example, is a keyboard or a mouse. Manual entry includes entering data values into a spreadsheet for example, the spreadsheet being stored in database 308. The operator can obtain outputs such as printouts and on-screen displays of the spreadsheet, as well as other information pertinent to computing element 205 via suitable devices such as printers and displays of I/O devices 315.

While the work load estimates may be derived from call-related statistics provided by a communication switch, in alternative embodiments, these estimates can be drawn up by predictions made by WFMS staff that do not rely on past call history. In some instances, past calling history merely provides a guideline/basis but not a firm value towards a work load estimate. Other factors such as growth of facilities, staff, and revenue may modify the work load estimate in a manner that is not necessarily consistent with past call history.

In one or more embodiments, call-related statistics include, but are not limited to the number of calls forwarded from communication switch 110 to one or more call centers, telephone numbers, call duration, originating source, call center identification and call center related data as well. Call center related data includes operator performance measurements using industry-wide practices such as, but not limited to, position seizures, revenue and deviations. It may also include a breakdown of the nature of the calls, such as the number of directory assistance calls and/or the number of toll calls. Additionally, it includes various work volumes related to these calls as recorded in the communication switch.

Other elements of data/information that are stored in database 308 will be identified or made obvious by further explanations that are done below with reference to other figures.

Computing element 205 may also communicate with various devices, such as personal computers, that are located in one or more call centers, to obtain data that is then stored in database 308. The communication between computing element 205 and the call centers takes place through communication switch 110, or through alternative means that do not involve communication switch 110. Such alternative means includes wireline/wireless communication devices such as microwave links, cell phones, and fiberoptic transceivers. Also included is written material, for example, documentation that is exchanged by regular mail between operators of the call centers and those of WFMS 100.

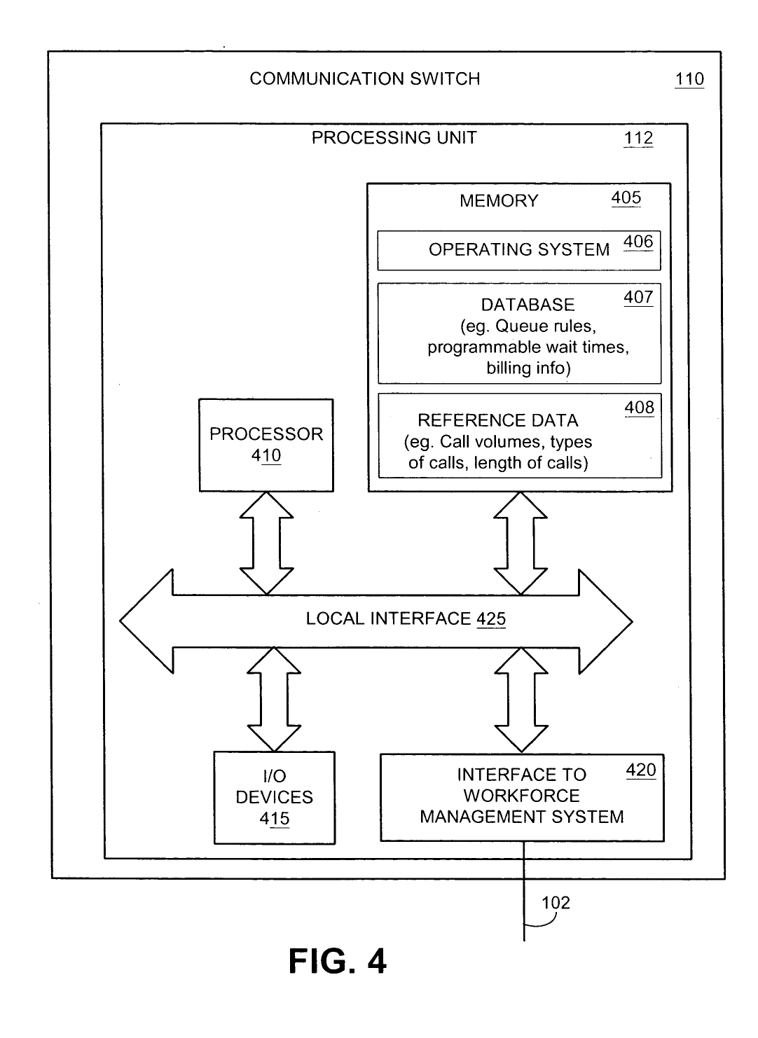

FIG. 4 is a block diagram illustrating various functional blocks incorporated inside processing unit 112 of communication switch 110. Generally, in terms of hardware architecture, as shown in FIG. 4, processing unit 112 includes a processor 410, memory 405, a WFMS interface 420, and one or more input and/or output (I/O) devices 415 (or peripherals) that are communicatively coupled via a local interface 425. It will be understood by persons of ordinary skill in the art, that the description of the hardware in FIG. 4 may be generally understood from the description provided for the equivalent hardware blocks shown in FIG. 3.

Processing unit 112 is generally configured to perform functions that are typically carried out by a controller circuit of a communication switch such as communication switch 110. Such functions typically encompass operations, administration, maintenance, and provisioning (OAMP) functions that are associated with switch 110. Additionally, processing unit 112 is configured to interface with WFMS 100 and to provide switching statistics to WFMS 100. This is carried out via WFMS interface 420 that transmits digital data to WFMS 100 through link 102.

Memory 405 includes database 407 and reference database 408. While shown as two distinct database, it will be understood that this has been done merely for purposes of explanation, and several other database configurations can be used alternatively. These configurations include the use of databases located inside elements other than processing unit 112. Database 407 may contain data that is used by communication switch 110, for example, queue rules, programmable wait times, billing data etc.

Database 408 contains data that is pertinent to vacation scheduling system 300. In the example where communication switch 110 is a POTS switch, this data comprises call-related data, such as, but not limited to, call volume over periods of time, call origination details, type of calls, average wait time, call-completed data such as call origination details, length of call, destination details, time data etc., call set-up data such as programmed wait times, call density, average wait time, and other such data.

While the data contained in databases 407 and/or 408 can be transmitted electronically as an electronic spreadsheet, an e-mail, or by other electronic media to WFMS 100, alternative transmission methods such as regular mail, telephone calls, faxes and other such media can also be employed to convey to WFMS 100, information from communication switch 110 that is relevant to vacation scheduling system 300.

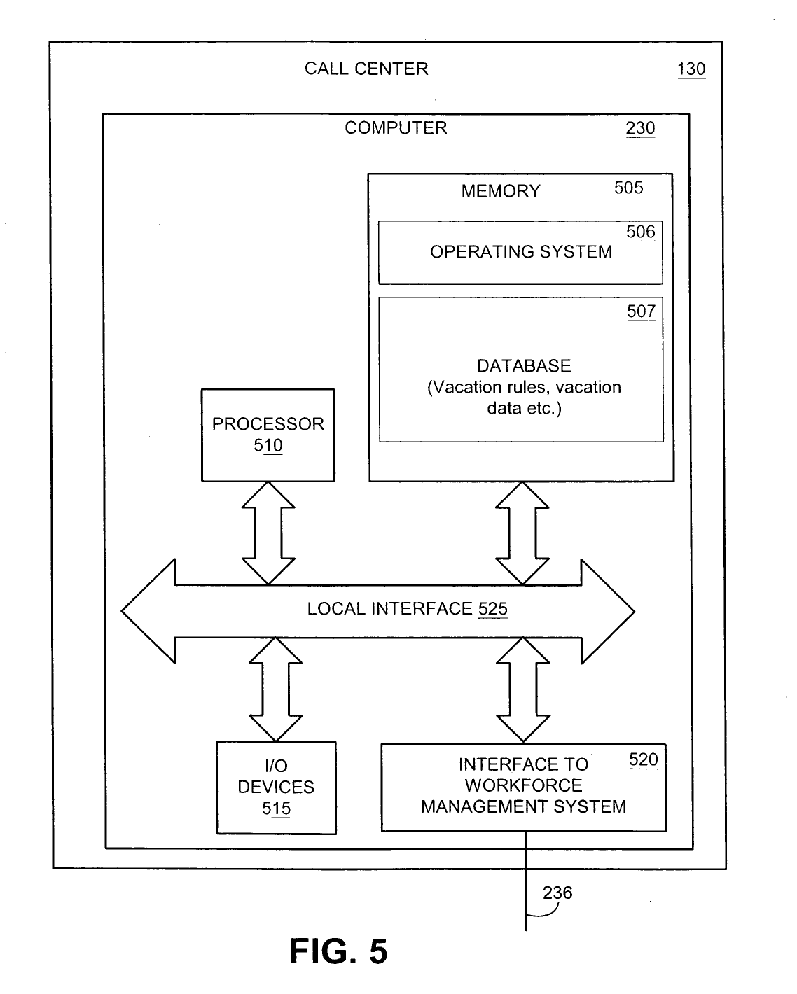

FIG. 5 is a block diagram illustrating various functional blocks incorporated inside computer 230 of call center 130. Generally, in terms of hardware architecture, as shown in FIG. 5, computer 230 includes a processor 510, memory 505, a WFMS interface 520, and one or more input and/or output (I/O) devices 515 (or peripherals) that are communicatively coupled via a local interface 525. It will be understood by persons of ordinary skill in the art, that the description of the hardware in FIG. 5 can be generally understood from the description provided for the equivalent hardware blocks shown in FIG. 4.

Computer 230 is a computing element that is a standalone device or a networked device located in call center 130, and is typically configured for use by administrative staff such as managers of the call center. Such a configuration generally encompasses operations, administration, and maintenance functions associated with managing the activities, such as payroll, vacation, and staffing, related to a number of call center operators switch 110. In some embodiments, computer 230 is configured to electronically and communicatively interface with WFMS 100 and provide various statistics to WFMS 100. This is carried out via WFMS interface 520 that transmits digital data to WFMS 100 through link 236.

Memory 505 includes one among several databases, a database 507 that contains data pertinent to vacation scheduling system 300. In one example of such data, database comprises vacation rules and vacation data related to operators of call center 130.

While the data contained in database 507 istransmitted electronically as an electronic spreadsheet, an e-mail, or by other electronic media to WFMS 100, alternative transmission methods such as regular mail, telephone calls, faxes and other such media are also employed to convey to WFMS 100, information from call center 130 that is relevant to vacation scheduling system 300.

Additionally, while FIG. 5 illustrates one exemplary embodiment, where data relevant to vacation request processing 300 is stored in database of a computer 230 in a call center 130, it will be understood that such data can be alternatively stored in electronic or non-electronic formats in other devices that are local or remote to WFMS 100. Such formats and devices include paper and other alternative storage/transmission media.

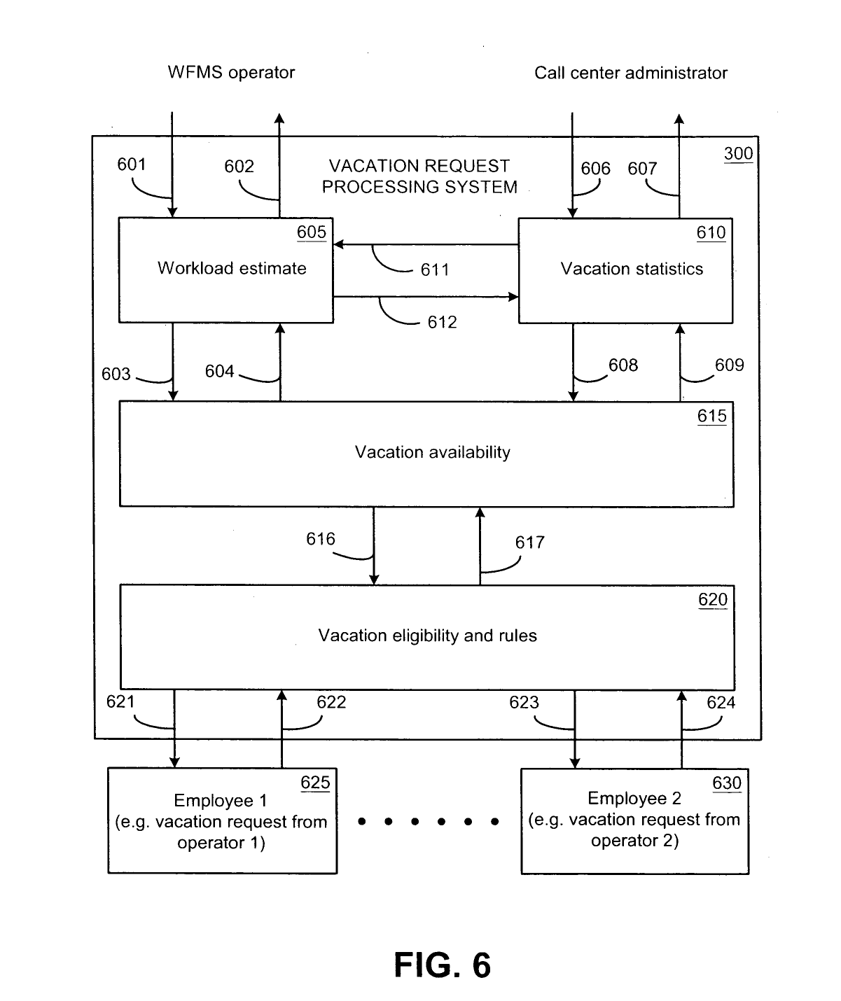

FIG. 6 is a block diagram illustrating various function blocks of one exemplary embodiment, among many, of a vacation request processing system 300. A WFMS operator accesses the workload estimate block 605 via I/O lines 601 and 602 to configure a workload estimate. The workload estimate block 605 incorporates call volume data, among other workload statistics, that has been obtained from a communication switch. Using lines 601 and 602, that are coupled to a data entry device such as a keyboard, the WFMS operator processes the workload statistics to create a workload estimate that includes the statistics themselves or derivations thereof. The workload statistics comprises for example, historic call volume statistics obtained from a POTS switch, where the call volume statistics are applicable over a period of time. The call volume statistics are obtained from the switch at various intervals ranging, for example, from daily to 10-minute intervals.

The workload estimate of workload estimate block 605 further includes call-handling statistics related to one or more call centers, that are obtained via link 611. Some examples of such call-handling statistics include measured/estimated values of parameters such as average work time (AWT), average talk time (ATT), base staff required, temporary staff required, calls per hour (CPH), average speed of answer (ASA), abandon rate (AR), headcount, loading factor, manned over paid (M/P), occupancy rate, total work time (TWT), and workload.

The output of the workload estimate block 605 comprises a combination of workload statistics and call-handling statistics, either in direct form, or in processed form. One example of a direct form relates to quantitative parameters such as a number of operators required to work a particular shift of a call center irrespective of the nature of the call-handling statistics. An example of a processed form is obtained by modifying the direct form using the call-handling statistics of the operators. Such modification occurs for example, when the estimated number of operators has to be increased due to the lack of experience amongst them.

The output of the workload estimate block 605 is provided to vacation statistics block 610 on a periodic or an aperiodic basis. Periodic deliveries comprise forecasts that are generally of a long-term nature, for example, an annual or a semi-annual workload estimate that will allow call center administrative staff to adjust their long-term staffing levels. Alternatively, the workload estimates are provided at comparatively shorter intervals that, in certain cases, comprise hourly reports that permit call center staff to adjust their operator staffing several times within a work day. Also, in the case of irregular events, such as a sudden spike in call volume traffic, the workload estimate is provided in an as-needed basis that is not periodic in nature.

The workload estimates is also provided via link 603 to vacation eligibility block 615 for processing of vacation requests. Vacation availability data from the vacation availability block 615 is transmitted to the workload estimate block 605 through link 604. This data is utilized in the workload estimate block 605 in calculating workload estimates.

A call center administrator accesses the vacation statistics block 610 via I/O lines 606 and 607 to update and/or review the vacation statistics of one or more call center operators. The call center administrator also reviews the recommendations received from the workload estimate block 605 via link 612 and acts upon these recommendations. Data related to this action, such as the extent to which the recommendations were accepted, operator exceptions data, and other operating limitations is sent to the workload estimate block 605, using link 611.

The vacation statistics block 610 also interfaces with the vacation availability block 615 via links 608 and 609. As one example of data transported on these links, the vacation statistics block 610 receives a vacation request related message/data on link 609, compares it to vacation balance availability data and suitably responds via link 608 by adjusting the operator's vacation balance after the call center administrator has approved the request.

Vacation availability block 615 processes information obtained from the workload estimate block 605 and the vacation statistics block 610, to reflect the current vacation status of one or more call center operators.

Vacation eligibility and rules block 620 processes vacation requests from one or more employees, such as employees 1 and 2 of FIG. 6, and applies vacation qualification criteria to allow/deny a request.

The rules of vacation eligibility and rules block 620 are set based on various criteria. Some examples of such criteria include, but are not limited to, a time of entry of the vacation request, an employee's length of service, an employee's pay grade, special employment contract terms, union rules, legal rules such as federal laws relating to employment, nature of employment (permanent, temporary, contract, etc.), and pay-related rules (e.g., overtime).

Vacation eligibility criteria is determined based on vacation availability data that is derived from the workload estimates as well as vacation statistics of one or more employees. Vacation eligibility and rules block 620 is also used to process vacation requests in a number of ways. One example among many, includes various modes of accepting such requests. These modes include, for example, manual entry by a local vacation request processing system 300 operator of a vacation request received over a phone/fax. A second mode is an electronic request, such as, but not limited to, a data entry application that is table driven, menu driven, and/or e-mail driven.

One example among several, of a vacation request and processing, comprises employee 2 originating a vacation request via an email transported on link 625. Vacation processing system 300 processes the request and determines that the vacation cannot be granted due to a lack of availability, such a lack of availability occurring due to a vacation having been granted earlier to employee 1. At a subsequent date, prior to the vacation date, employee 1 decides to cancel his vacation request. Since the vacation day is now available, vacation request processing system 300 originates and transmits an email, via link 623, to employee 2, providing him an opportunity to accept the grant of his earlier-denied vacation request.

As a second example, employees 1 and 2 and/or a call center administrator negotiates vacation dates, using the vacation request processing system 300 to arrive at mutually acceptable vacation dates.

Configuration and/or access operations of the various blocks of vacation request processing system 300 is carried out by one or more personnel with several degrees of authorization. For example, a WFMS operator accesses certain databases of workload estimate block 605 that are out-of-bounds to a call center administrator or a call center operator. Alternatively, a call center administrator is authorized to access and configure vacation eligibility and rules block 620 whereas an WFMS operator is not authorized to access any database related to this block. Similarly, various levels of authority are assigned to various personnel to permit override capabilities, where operations of the vacation request processing system 300 can be cancelled/modified when such operations are found to be unsuitable/undesirable.

Data flows inside vacation request processing system 300 comprises transport of information in many different formats. A few examples of such formats include, but are not limited to, voice communications, fax communications, paper documents, digital data such as bits representing alphanumeric values, electronic text, and electronic digital data.

To illustrate one exemplary data flow inside vacation request processing system 300, a vacation request originated by employee 2, travels via link 624 into vacation request processing system 300. The request is processed via data/message flows using links 617, 609, and 607. The call center administrator, who is the manager/supervisor of employee 2, then grants the request, or suitably forwards the request to an appropriate manager. Subsequently, the grant/denial of the request utilizes links 606, 608, 616, and 623.

Additional features of the vacation request processing system 300 includes generation of error messages and suitable responses to rule violations by one or more persons accessing the system. In one such example, if a call center administrator denied a vacation request, where such a denial would violate certain rules, say a union rule, an error notification is generated to the call center administrator, and his action of denying the request is preempted.

In a second example, if an employee requested a vacation after exceeding his permitted quota, the request is denied right away and the request is preempted from being entered and/or being processed any further.

In a third example, where the rules permit, a call center administrator insists/requests an employee to cancel/re-schedule his or her vacation based upon information received in vacation statistics block 610 from workload estimate block 605 indicating that a workload projection does not permit vacation to be taken by more than a certain number of operators during a certain period of time.

It should be emphasized that the above-described embodiments of the present disclosure are merely possible examples of implementations and are set forth merely for providing a clear understanding of the principles of the disclosure. Many variations and modifications may be made to the above-described embodiment(s) of the disclosure without departing substantially from the spirit and principles of the disclosure. For example, it will be understood by persons of ordinary skill in the art, that several implementations upon several switches other than POTS switches can be carried out to implement this vacation scheduling system. All such modifications and variations are intended to be included herein within the scope of this disclosure and the present disclosure and protected by the following claims.

1. A vacation request processing system comprising:
logic configured to provide a workload estimate comprising at least a first workload statistic that is used to operate a first call center;
logic configured to provide a vacation eligibility criteria based on at least a first rule; and
logic configured to process the vacation request of a first employee based on the workload estimate and the vacation eligibility criteria.

2. The system of claim 1, wherein the first workload statistic comprises an estimated volume of telephone calls that the first call center is expected to handle over a first period of time.

3. The system of claim 1, wherein the first workload statistic comprises an estimated volume of telephone calls that the first call center is expected to handle over a first period of time, and wherein the estimated volume of telephone calls is derived from historical call volume data obtained from a communications switch.

4. The system of claim 1, wherein the first workload statistic comprises an expected number of operators needed to operate the first call center during a first period of time.

5. The system of claim 1, wherein the first workload statistic is derived from telephone call data stored in a database of a POTS switch.

6. The system of claim 1, wherein the first rule is derived from an employment grade of the first employee, and wherein the employment grade comprises at least one of a payscale and a length of service of the first employee.

7. The system of claim 1, wherein the workload estimate is provided to the first call center in a timely basis, the timely basis comprising at least one of an hourly basis, a daily basis, a weekly basis, a monthly basis, a quarterly basis, a semi-annual basis, and an annual basis.

8. The system of claim 7, wherein the vacation eligibility criteria is provided in a timely basis, the timely basis comprising at least one of an hourly basis, a daily basis, a weekly basis, a monthly basis, a quarterly basis, a semi-annual basis, and an annual basis.

9. The system of claim 1, wherein logic configured to process the vacation request comprises:
logic configured to receive the vacation request of the first employee;
logic configured to deny the vacation request due to a lack of vacation availability at a time of the vacation request; and
logic configured to grant the vacation request due to a vacation availability at a time after the vacation request was denied.

10. The system of claim 9, wherein granting the vacation request comprises transmitting an e-mail to the first employee.

11. A method of processing a vacation request, the method comprising:
providing a workload estimate comprising at least a first workload statistic that is used to operate a first call center;
providing a vacation eligibility criteria based on at least a first rule; and
processing the vacation request of a first employee based on the workload estimate and the vacation eligibility criteria.

12. The method of claim 11, wherein the first workload statistic comprises an estimated volume of telephone calls that the first call center is expected to handle over a first period of time.

13. The method of claim 11, wherein the first workload statistic comprises an estimated volume of telephone calls that the first call center is expected to handle over a first period of time, and wherein the estimated volume of telephone calls is derived from historical call volume data obtained from a communications switch.

14. The method of claim 11, wherein the first workload statistic comprises an expected number of operators needed to operate the first call center during a first period of time.

15. The method of claim 11, wherein the first workload statistic is derived from telephone call data stored in a database of a POTS switch.

16. The method of claim 11, wherein the first rule is derived from an employment grade of the first employee, and wherein the employment grade comprises at least one of a payscale and a length of service of the first employee.

17. The method of claim 11, wherein the workload estimate is provided to the first call center in a timely basis, the timely basis comprising at least one of an hourly basis, a daily basis, a weekly basis, a monthly basis, a quarterly basis, a semi-annual basis, and an annual basis.

18. The method of claim 17, wherein the vacation eligibility criteria is provided in a timely basis, the timely basis comprising at least one of an hourly basis, a daily basis, a weekly basis, a monthly basis, a quarterly basis, a semi-annual basis, and an annual basis.

19. The method of claim 11, wherein processing the vacation request comprises:
receiving the vacation request of the first employee;
denying the vacation request due to a lack of vacation availability at a time of the vacation request; and
granting the vacation request due to a vacation availability at a time after the vacation request was denied.

20. The method of claim 19, wherein granting the vacation request comprises transmitting an e-mail to the first employee.

21. The system of claim 11, further comprising:
means for receiving the vacation request of the first employee;
means for denying the vacation request due to a lack of vacation availability at a time of the vacation request; and
means for granting the vacation request due to a vacation availability at a time after the vacation request was denied.

22. A vacation request processing system stored on a computer-readable medium, the system comprising:
computer-readable code that provides a workload estimate comprising at least a first workload statistic that is used to operate a first call center;
computer-readable code that provides a vacation eligibility criteria based on at least a first rule; and
computer-readable code that processes the vacation request of a first employee based on the workload estimate and the vacation eligibility criteria.

23. The system of claim 22, wherein the first workload statistic comprises an estimated volume of telephone calls that the first call center is expected to handle over a first period of time.

24. The system of claim 22, wherein the first workload statistic comprises an estimated volume of telephone calls that the first call center is expected to handle over a first period of time, and wherein the estimated volume of telephone calls is derived from historical call volume data obtained from a communications switch.

25. The system of claim 22, wherein the first workload statistic comprises an expected number of operators needed to operate the first call center during a first period of time.

26. The system of claim 22, wherein the first workload statistic is derived from telephone call data stored in a database of a POTS switch.

27. The system of claim 22, wherein the first rule is derived from an employment grade of the first employee, and wherein the employment grade comprises at least one of a payscale and a length of service of the first employee.

28. The system of claim 22, wherein the workload estimate is provided to the first call center in a timely basis, the timely basis comprising at least one of an hourly basis, a daily basis, a weekly basis, a monthly basis, a quarterly basis, a semi-annual basis, and an annual basis.

29. The system of claim 28, wherein the vacation eligibility criteria is provided in a timely basis, the timely basis comprising at least one of an hourly basis, a daily basis, a weekly basis, a monthly basis, a quarterly basis, a semi-annual basis, and an annual basis.

30. The method of system 22, wherein computer-readable code that processes the vacation request comprises:
computer-readable code that receives the vacation request of the first employee;
computer-readable code that denies the vacation request due to a lack of vacation availability at a time of the vacation request; and
computer-readable code that grants the vacation request due to a vacation availability at a time after the vacation request was denied.

31. The system of claim 30, wherein in granting the vacation request computer-readable code transmits an e-mail to the first employee.
